(19) United States
(12) Patent Application Publication
(10) Pub. No.: US 2014/0052884 A1
(43) Pub. Date: Feb. 20, 2014

(54) MOBILE DEVICE CASE WITH WIRELESS HIGH DEFINITION TRANSMITTER

(71) Applicants: Shawn Rogers, Anaheim, CA (US); Steven Joe, Coto de Caza, CA (US)

(72) Inventors: Shawn Rogers, Anaheim, CA (US); Steven Joe, Coto de Caza, CA (US)

(73) Assignee: Zyxel Communications, Inc., Anaheim, CA (US)

(21) Appl. No.: 13/585,672

(22) Filed: Aug. 14, 2012

(51) Int. Cl. G06F 13/00

(52) U.S. Cl. 710/303

(57) ABSTRACT

The subject matter disclosed herein relates to a mobile device case to receive video signals from a physically connected mobile device and wirelessly transmit high definition video signals based, at least in part, on the video signals.

### FIELD

The subject matter disclosed herein relates to a mobile device case to receive video signals from a physically connected mobile device and to wirelessly transmit high definition video signals based, at least in part, on the video signals.

### BACKGROUND

A mobile device, such as a smartphone, for example, may comprise a portable electronic device built on a mobile computing platform for personal telecommunications and/or computing. In addition to standard voice function, smartphones may support additional functions such as Short Message Service (SMS) for text messaging, email, packet switching for access to the Internet, video playback, and Multimedia Messaging Service (MMS) to send and receive photos and video, just to name a few examples. Because of their small size, mobile telephones may be preferred over other electronic devices such as a personal organizer, day planner, and/or personal planner.

A tablet computer may comprise another type of mobile device built on a mobile computing platform. A tablet computer may provide a platform for audio-visual media such as books, movies, music, games, and Internet content, just to name a few examples.

In addition to providing a stand for short-term storage, a docking station may be used to charge a smartphone, a tablet computer, or other device, for example.

### BRIEF DESCRIPTION OF THE DRAWINGS

Non-limiting and non-exhaustive embodiments will be described with reference to the following objects, wherein like reference numerals refer to like parts throughout the various objects unless otherwise specified.

FIG. 1 shows front views of a mobile device case and a mobile device, according to an embodiment.

FIG. 2 shows a front view and a side view of a mobile device case retaining a mobile device, according to an embodiment.

FIG. 3 shows a front view and a side view of a mobile device case, according to an embodiment.

FIG. 4 is a block diagram of a mobile device case and associated components, according to an embodiment.

FIG. 5 is a flow diagram of a process to transmit wireless high definition signals to a receiver, according to an embodiment.

FIGS. 6 and 7 schematically show embodiments of a mobile device case retaining a mobile device and transmitting wireless high definition signals to a receiver.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Reference throughout this specification to “one embodiment” or “an embodiment” may mean that a particular feature, structure, or characteristic described in connection with a particular embodiment may be included in at least one embodiment of claimed subject matter. Thus, appearances of the phrase “in one embodiment” or “an embodiment” in various places throughout this specification are not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context of usage. Therefore, the particular context of the description or the usage of these terms may provide helpful guidance regarding inferences to be drawn for that context.

As used to describe such embodiments, terms “above”, “below”, “upper”, “lower”, “horizontal”, “vertical”, and “side” describe relative positions and/or directions that do not necessarily refer to a direction defined by gravity or any other particular orientation. Instead, such terms are merely used to identify one portion versus another portion. Accordingly, “upper” and “lower” may be equivalently interchanged with “top” and “bottom”, “first” and “second”, “right” and “left”, and so on. “Horizontal” may refer to an orientation perpendicular to a particular axis while “vertical” may refer to an orientation parallel to the particular axis.

Embodiments described herein include a mobile device case (MDC) to hold or retain a mobile device (MD), during which the MDC may receive video signals from the MD. In turn, the MDC may wirelessly transmit video signals, such as wireless high definition (WiHD) signals, for example, to a receiver, for example. Such a receiver may comprise a WiHD receiver, though claimed subject matter is not so limited. “WiHD” may refer to a particular standard, such as that based, at least in part, on a 7.0 GHz channel in a 60.0 GHz Extremely-High-Frequency radio band, for example. An MD (e.g., a portable device) may comprise a smartphone, a tablet computer, or other portable computing device, just to name a few examples. Such an MD may include one or more rechargeable batteries, which may be recharged by an MDC, according to an embodiment. Moreover, an MDC may include one or more rechargeable batteries that may be recharged via a cable or wires by an external power source.

In some implementations, an MD may provide High-Definition Multimedia Interface (HDMI) signals to an MDC, which in turn may wirelessly transmit such signals (or other signals based, at least in part, on such HDMI signals) to a receiver located remotely from the MDC. Such a receiver may comprise a television, a monitor (e.g., a computer monitor), or other display device, just to name a few examples. In other examples, such a receiver may comprise a stand-alone device connected to a television, a monitor (e.g., a computer monitor), or other display device. In one implementation where video signals may comprise WiHD streaming video, such a receiver may comprise a WiHD receiver and an MDC may comprise a WiHD transmitter, though claimed subject matter is not so limited.

In one implementation, an MD may include motion sensors to detect motion or orientation of the MD. In such a case, for example, a user may input information to an MD by moving the MD, such as during game playing. In a particular example, a game or program may include video displayed on a TV or monitor. Such video may be provided by an MD via an MDC that wirelessly streams video signals to the TV or monitor. A user may interact with a game or program by moving (e.g., rotating, translating, shaking, and so on) an MD. Accordingly, a game or program being executed in an MD may respond to such MD movements by generating video signals based, at least in part, on such movements. Such video signals may be provided to an MDC while the MD is retained in the MDC. Thus, via an MDC, a TV or monitor may display generated video signals in real time as a user interacts with the game or program. Moreover, an MDC need not use wires or cables, which may undesirably restrict a user's motion, to transmit video signals to a TV or monitor.

An MDC need not be limited to wireless operations. For example, an MDC may include a connector port to connect to a docking station, during which the MDC may receive electrical power from an alternating current (AC) power supply (e.g., wall outlet) via the docking station.

In an embodiment, an MDC may comprise a recessed region to receive and at least partially retain a mobile device. Here, an MD may be “retained” if a connector on the MD is connected to a mating connector disposed in or near an edge of the recessed region. Such retention may also involve an MD being physically held to an MDC. For example, friction between edges of an MD and corresponding edges of a recessed region of an MDC may be sufficient to hold the MD to the MDC. Mating connectors of the MDC and the MD may also contribute to holding the MD to the MDC, for example. While an MD is retained by an MDC, the MDC may receive video signals from the MD via a connector on the MD mated with a connector on the MDC. Such video signals may comprise HDMI signals, for example.

In an embodiment, an MDC may include electronic circuitry to produce video signals (e.g., high definition wireless signals) based, at least in part, on video signals received from a retained MD. In a case where video signals comprise a format other then HDMI signals, an MDC may further include a microprocessor or other electronics to convert video signals to HDMI signals, though claimed subject matter is not so limited. An MDC may also include a plurality of antennas and a transmitter to transmit video signals. For example, a plurality a WiHD antennas and a transmitter may transmit WiHD signals via the WiHD antennas. As mentioned above, an MDC may include one or more rechargeable batteries to provide power to electronic circuitry to transmit video signals. In one implementation, an MDC may include a second connector to receive power to recharge the rechargeable batteries, as explained in detail below. Such rechargeable batteries may comprise lithium-ion batteries, for example.

In an embodiment, a method of operating an MDC with a mobile device may comprise receiving the MD at least partially in a recessed region of the MDC so as to connect an MD connector to an MDC connector. Upon or after such a connection, video signals may be received from the MDC via the MD connector and the MDC connector. The MDC may include electronic circuitry to produce high definition wireless signals based, at least in part, on the received video signals. The high definition wireless signals may then be transmitted via a plurality of antennas, such as WiHD antennas. As mentioned above, such video signals may comprise HDMI signals.

In one particular implementation, an MDC may include a re-writeable register to store, among other things, a code comprising one or more bits, bytes, characters, words, or the like. Such a code may be read by an MD retained in the MDC. Accordingly, an MD may identify the MDC upon or after reading such a code. For example, an MD may determine what type of video signal to provide to an MDC based, at least in part, on such a code. A video signal may comprise any of a variety of types of video signals having various formats or video quality, for example. In an implementation, an MD may determine a rate a which a video signal may be transmitted to an MDC based, at least in part, on a code stored in a re-writeable register. For example, different types of MDCs (or MDCs configured differently from one another) may have different capabilities of receiving or processing video signals provided by an MD. In an implementation, a code stored in a re-writeable register may be replaced (e.g., over-written) by a new code. For example, a new code may correspond to recently upgraded capabilities of an MDC to process video signals. In one implementation, code may be written to a re-writeable register from an MD retained by the MDC. For example, software executed in an MD may generate (or a user may enter via the MD) a code to be written to a re-writeable register in the MDC. In another implementation, code may be written to a register, which need not be re-writeable, at a time of manufacturing an MDC. Of course, such details of code stored in a register are merely examples, and claimed subject matter is not so limited.

An MDC may provide a number of benefits directed to wirelessly transmitting video signals from a mobile device. For example, electronic circuitry or electronic components (e.g., chipsets or one or more integrated circuits) to process or wirelessly transmit video signals (such as WiHD signals, for example) may be too large to physically fit into relatively small mobile devices. However, such electronic circuitry or electronic components may fit into an MDC. Also, in an embodiment, wirelessly transmitting video signals may involve a relatively large plurality (e.g., 30) of antennas. While a relatively small sized mobile device may not be able to contain such a number of antennas, an MDC may include these antennas. It should be noted that mobile devices may include Bluetooth components capable of wirelessly transmitting signals. However, such Bluetooth components may not be capable of processing or wirelessly transmitting signals having a relatively large bandwidth, as in the case for video signals, for example.

An MDC may also provide another benefit directed to wirelessly transmitting video signals from a mobile device. Electronic circuitry or electronic components (e.g., chipsets or one or more integrated circuits) to process or wirelessly transmit video signals may use a relatively large amount of electrical power. A physical size of one or more batteries to provide such a large amount of power may be too large to physically fit into relatively small mobile devices. However, such one or more batteries may fit into an MDC.

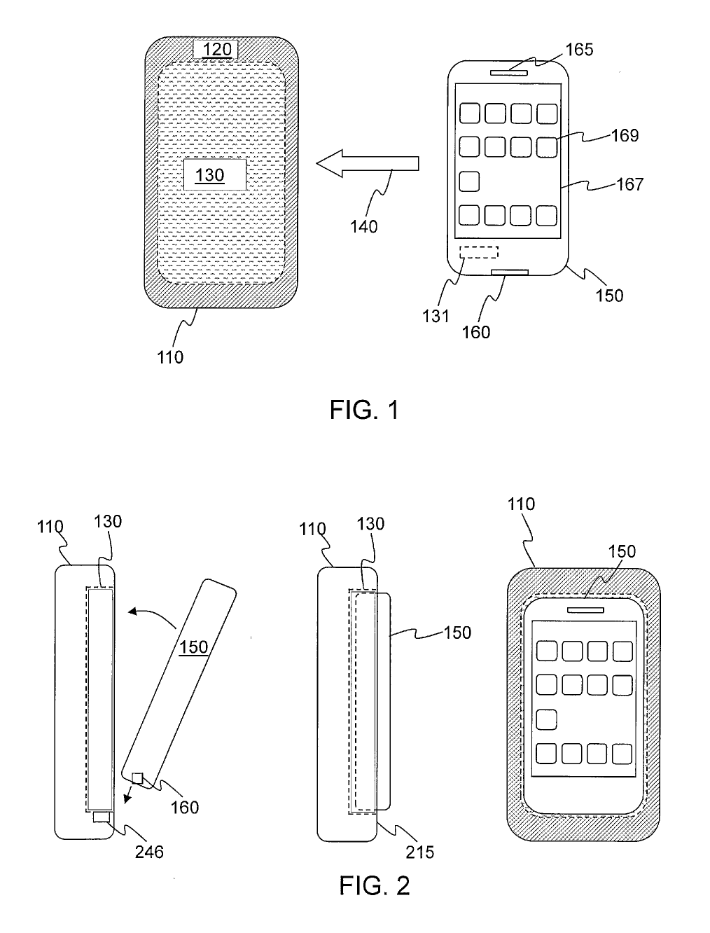

FIG. 1 shows front views of an MDC 110 and an MD 150, according to an embodiment. For example, MD 150 is shown to comprise a touch screen (e.g. display) 167 including a number of icons 169, any of which a user may select. In other embodiments, an MD need not comprise a touch screen, but instead may have a keypad, for example. MD 150 may further comprise a speaker 165 and a connector 160. In some implementations, connector 160 may be used to exchange data with an external device, such as a computer, for example. Connector 160 may also be used to receive electrical power to recharge batteries (shown in FIG. 3, for example) or to operate electronics in MD 150. MD 150 may also include motion detection components 131, such as an accelerometer or compass, just to name a few examples.

MDC 110 may include a recessed region 130 bordered by a raised portion 120. Recessed region 130 may have a surface area or dimensions that correspond, at least approximately, to dimensions (e.g., length and width) of MD 150. A depth of recessed region 130 with respect to a top surface of raised portion 120 may be less than or greater than a depth of MD 150. For example, the depth of recessed region 130 may be half the depth of MD 150, though claimed subject matter is not so limited.

As indicated by arrow 140, MD 150 may be placed into recessed region 130 of MDC 110 so that MD 150 is retained by MDC 110. Though not shown in FIG. 1 (but shown in FIG. 3, for example), MDC 110 may include a connector to correspond to connector 160 of MD 150. As explained above, MD 150 may be retained by MDC 110 upon or after MD connector 160 and a connector of MDC 110 are mated. Accordingly, placing MD 150 at least partially into MDC 110 may include connecting MD connector 160 to a connector of MDC 110. Of course, details of MDC 110 and MD 150 are merely examples, and claimed subject matter is not so limited.

FIG. 2 shows a front and side view of MDC 110 retaining MD 150, according to an embodiment. The left-most figure depicts a motion involved in placing MD 150 into MDC 110 to be retained by MDC 110, according to a particular implementation. For example, MD 150 may be held at an angle with respect to MDC 110 while MD connector 160 is directed toward MDC connector 246. Upon or after MD connector 160 is at least partially mated with MDC connector 246, MD 150 may be rotated into a position to be received by recessed region 130.

As shown in the particular embodiment of FIG. 2, MD 150, while retained by MDC 110, may protrude from a top surface 215 of MDC 110. In other embodiments, MD 150 need not protrude, and claimed subject matter is not so limited. Again, details of MDC 110 and MD 150 are merely examples, and claimed subject matter is not so limited.

FIG. 3 shows a front view and a side view of an MDC, according to an embodiment 300. MDC 310 may include any of a number of components or electronic circuitry. Such components or electronic circuitry may be located in an interior portion of MDC 310 below a casing surface 302 of recessed region 330, for example. Recessed region 330 may be located in a front side 311 of MDC 310. In particular, MDC 310 may include a first connector 346 disposed at least partially in recessed region 330. First connector 346 may connect with a mobile device while the mobile device is disposed or retained in the recessed region. Accordingly, first connector 346 may receive video signals from a mobile device disposed or retained in recessed region 330, for example. As mentioned above, such video signals may comprise HDMI signals.

In an embodiment, first connector 346 may comprise a first configuration, wherein the first connector may be interchangeable with another connector comprising a second configuration. For example, first connector 346 may be user-interchangeable among connectors having different pin-outs. In such a fashion, the first connector may be interchangeable to accommodate two or more different types of mobile devices. For example, one mobile device may be configured according to one standard connection protocol while another mobile device may be configured according to another standard connection protocol. One example of a standard connection includes a 30-pin iPOD connector used by a number of products (e.g., Apple iPod, Apple iPhone, and others) manufactured by Apple Incorporated, located in Cupertino, Calif. Another example of a standard connection includes a 14-pin Smartphone connector used by a number of mobile device manufactures.

First connector 346 comprising a first connector type may be removed and/or replaced with another connector type. “User-interchangeable” refers to an example where a user may perform connector removal and/or replacing operations. For example, a user-interchangeable connector may include a plug/socket for relatively simple connector removal and/or replacement. As a counter-example, a connector may not be user-interchangeable if such a connector is soldered and/or hardwired in place during manufacturing of a docking device. It should be noted that some embodiments of MDC 310 may comprise first connector 346 that is not user-interchangeable. In such embodiments, first connector 346 may be selected and placed in MDC 310 during manufacture of MDC 310. In such embodiments, MDC 310 may comprise different “models” comprising a first connector 346 having different configurations, though claimed subject matter is not limited to any such example embodiments.

MDC 310 may further include circuitry, such as WiHD electronic circuitry 312 to, among other things, produce video signals based, at least in part, on the video signals (e.g., HDMI signals). In a case where video signals comprise a format other then HDMI signals, electronic circuitry 312 may further include a microprocessor or other electronics to convert video signals to HDMI signals, though claimed subject matter is not so limited.

Electronic circuitry 312 may include a transmitter 352 to wirelessly transmit video signals via a plurality (e.g., ten or more) of antennas 344, which may comprise WiHD antennas, for example. Though claimed subject matter is not so limited, antennas 344 may be located in a side region 319 of MDC 310. Such a location may be useful by helping to avoid antennas 344 being covered by a hand of a user holding MDC 310, for example. A majority of users may hold MDC 310 with their left hand, for example. In other implementations, antennas 344 may be located in a top region, for example (antennas 344 located in a bottom region 317 may be at least partially blocked if MDC 310 is docked at a docking station, described below, for example).

As mentioned above, MDC 310 may include one or more rechargeable batteries 314 to provide power to electronic circuitry 312, antennas 344, and other electronics included in MDC 310, for example. In one implementation, rechargeable batteries 314 may also provide power to an MD retained in recessed region 330. For example, MDC 310 may include power circuitry 354 to provide power to an MD from one or more rechargeable batteries 314. MDC 310 may include a second connector 342 to receive power to recharge rechargeable batteries 314. Though second connector 342 is shown to be disposed on a side of MDC 310, second connector 342 may be disposed in any portion of MDC 310. In some embodiments, MDC 310 need not include a second connector, wherein first connector 346 may receive power to recharge rechargeable batteries 314.

In one particular implementation, MDC 310 may include a re-writeable register 316 to store, among other things, a code comprising one or more bits, bytes, characters, words, or the like. Such a code may be read by an MD retained in MDC 310. Accordingly, an MD may identify MDC 310 upon or after reading such a code. Re-writeable register 316 may comprise any of a number of memory types, such as flash, just to name an example. Of course, details of MDC 310 are merely examples, and claimed subject matter is not so limited.

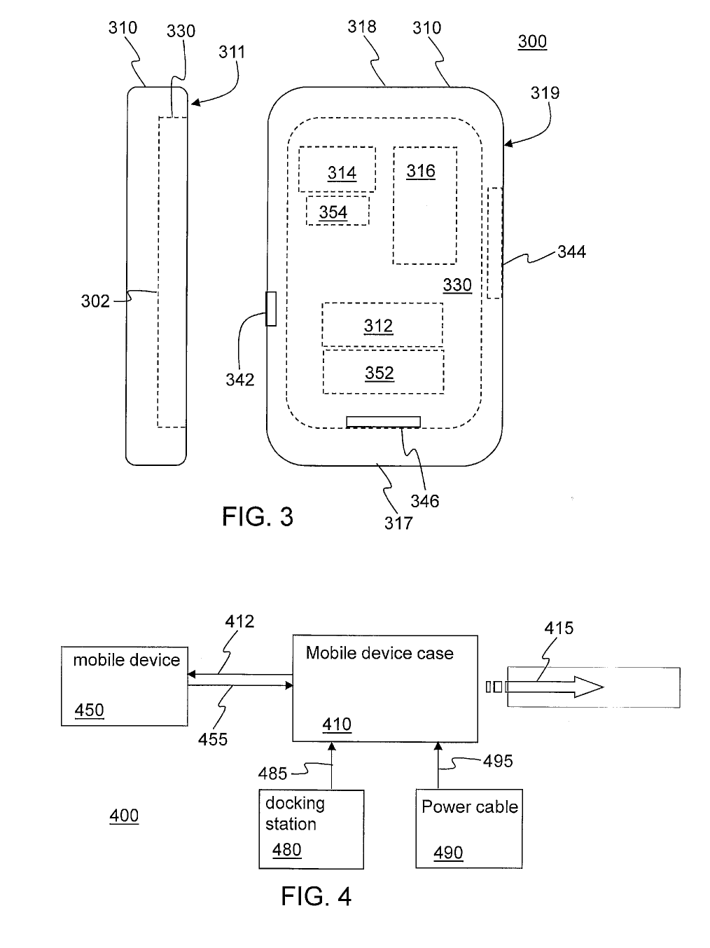

FIG. 4 is a block diagram of a mobile device case and associated components, according to an embodiment 400. MDC 410 may receive information 455 from MD 450 while MD 450 is retained by MDC 410. For example, information 455 may comprise, among other things, video signals (e.g., HDMI signals). On the other hand, MD 450 may receive information 412 from MDC 410 while MD 450 is retained by MDC 410. For example, information 412 may comprise, among other things, a code comprising one or more bits, bytes, characters, words, or the like. As mentioned above, a code stored in a re-writeable register, such as 316 for example, may be read by MD 450. Accordingly, MD 450 may identify MDC 410 upon or after reading such a code. For example, MD 450 may determine what type of video signal to provide to MDC 410 based, at least in part, on such a code. A video signal may comprise any of a variety of types of video signals having various formats or video quality, for example. In an implementation, MD 450 may determine a rate at which a video signal may be transmitted to MDC 410 based, at least in part, on such a code.

In an embodiment, MDC 410 may be docked at a docking station 480. For example, MDC 410 may include a second connector, such as 342 shown in FIG. 3, to receive power 485 from docking station 480 to recharge rechargeable batteries in MDC 410 or MD 450. Such a second connector may be disposed on MDC 450 so as to be connectable to docking station 480. For example, a second connector may be disposed in a bottom region 317, shown in FIG. 3. In another embodiment, a second connector may be adapted to receive a power 495 from a power cable 490. Such a power cable may transfer power from an external (e.g., an electrical wall outlet) power source, for example. Power 495 may be used to recharge rechargeable batteries in MDC 410 or MD 450.

In an embodiment, MDC 410 may wirelessly transmit video signals 415 (e.g., WiHD signals). Such signals may be received by a receiver located remotely from MDC 410. As mentioned above, such a receiver may comprise a television, a monitor (e.g., a computer monitor), or other display device, just to name a few examples. In other examples, such a receiver may comprise a stand-alone device connected to a television, a monitor (e.g., a computer monitor), or other display device. In one particular implementation, wherein video signals comprise WiHD streaming video, such a receiver may comprise a WiHD receiver and MDC 410 may comprise a WiHD transmitter, though claimed subject matter is not so limited. In one implementation, such a WiHD transmitter may be capable of transmitting video signals 415 at a rate greater than 4.0 gigabits per second. In another implementation, video signals 415 may comprise audio signals. Of course, details of MDC 410 and MD 450 are merely examples, and claimed subject matter is not so limited.

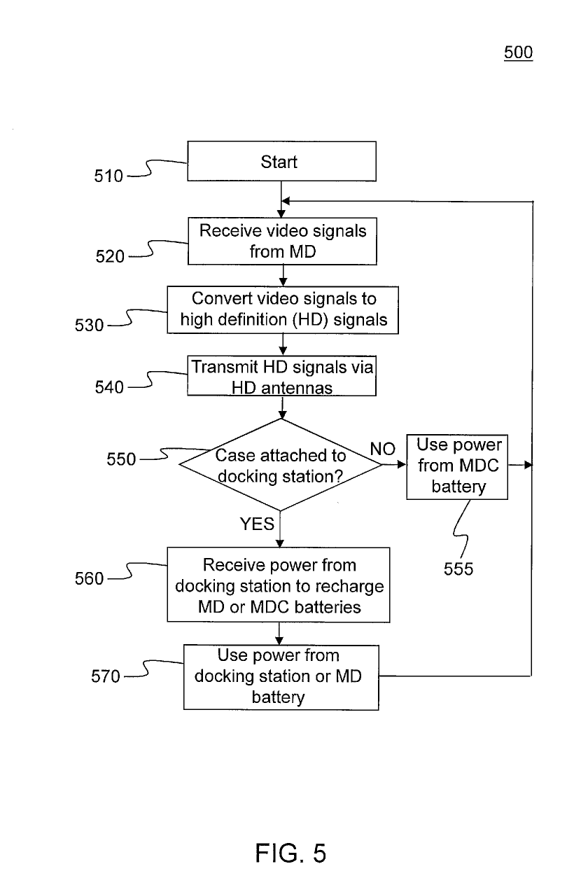

FIG. 5 is a flow diagram of a process 500 to transmit wireless high definition signals to a receiver, according to an embodiment. Block 510 marks a particular start of process 500, though claimed subject matter is not so limited. At block 520, video signals, such as HDMI video signals, may be received from an MD retained in an MDC. At block 530, such video signals may be converted to video signals, as described above. At block 540, video signals may be transmitted using a plurality of antennas, such as 344 shown in FIG. 3, for example. Transmitted video signals may subsequently be received by a receiver, which may be located at a monitor or television, for example.

At diamond 550, a determination may be made as to whether the MDC is attached or docked at a docking station. If not, then process 500 may proceed to block 555, where one or more batteries in the MDC may be used to provide power to electronics in the MDC. On the other hand, if the MDC is attached or docked at a docking station, process 500 may proceed to block 560, where electrical power may be provided to the MDC or MD via the docking station. Such electrical power may be used to recharge batteries in the MDC or MD. Moreover, at block 570, power received via the docking station may be used to provide power to electronics in the MDC or MD. Process 500 may return to block 520, for example. Of course, details of process 500 are merely examples, and claimed subject matter is not so limited.

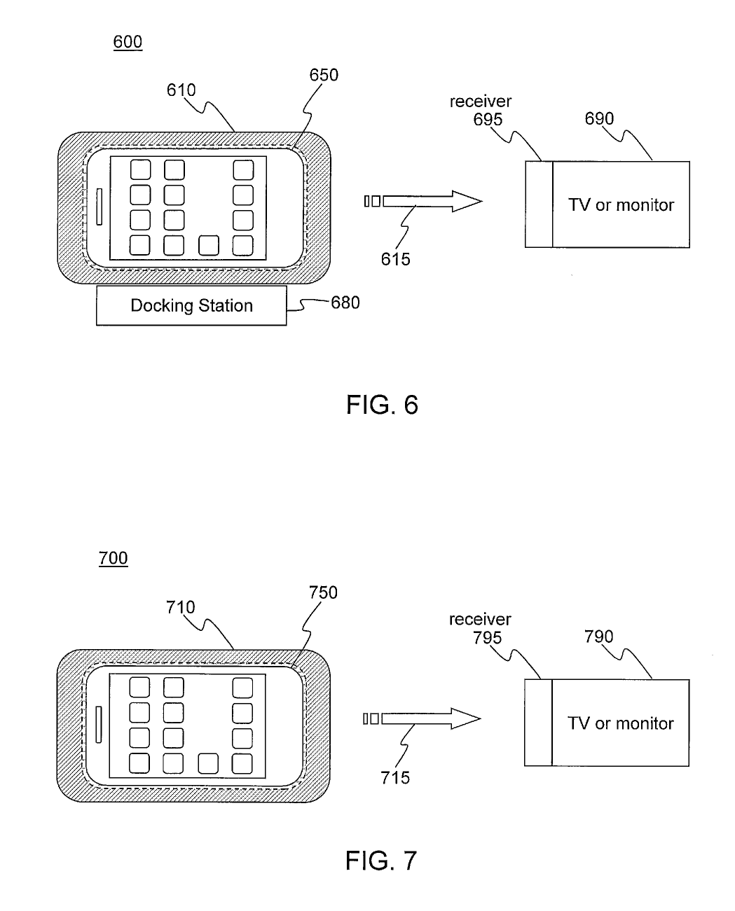

FIGS. 6 and 7 schematically show embodiments of a mobile device case retaining a mobile device and transmitting wireless high definition signals to a receiver. Though the figures show an MDC oriented on its side, claimed subject matter is not so limited. For example, an MDC may be held in a user's hand or pocket while MDC performs a process of receiving video signals from a retained MD and wirelessly transmits video signals (e.g., process 500). Moreover, an MDC need not be on its side to be docked at a docking station. Such orientations are merely examples, and claimed subject matter is not so limited.

In embodiment 600, an MD 650 may be retained by an MDC 610. Furthermore, MDC 610 may be docked at a docking station 680. In such a case, electrical power may be provided to MDC 610 or MD 650 via docking station 680. Such electrical power may be used to recharge batteries in the MDC or MD. Also, power received via docking station 680 may be used to provide power to electronics in MDC 610 or MD 650, wherein power received via docking station 680 need not recharge batteries in the MDC or MD.

MDC 610 may transmit video signals 615 to a receiver 695, which may provide video signals to a TV or monitor 690. Accordingly, video (e.g., multimedia, such as movies, video clips, and so on) stored in or received by MD 650 may be wirelessly transmitted by MDC 610 to receiver 695 to be viewed on TV 690, for example. Because of the availability of electrical power from via docking station 680, embodiment 600 may be particularly useful for viewing multimedia stored on or received by MD 650 on TV 690.

In embodiment 700, an MD 750 may be retained by an MDC 710. Contrary to the embodiment shown in FIG. 6, MDC 710 need not be docked at a docking station. In such a case, electrical power may be provided to MDC 710 or MD 750 via by rechargeable batteries in the MDC or MD. Similar to embodiment 600, MDC 710 may transmit video signals 715 to a receiver 795, which may provide video signals to a TV or monitor 790. Because of the portability of MDC 710 with MD 750, embodiment 700 may be particularly useful for playing games executed on or received by MD 750 using motion controls in MD 750. Video of the game, for example, may be displayed on TV 790. Of course, details of MDC 610/710 and MD 650/750 are merely examples, and claimed subject matter is not so limited.

One skilled in the art will realize that a virtually unlimited number of variations to the above descriptions is possible, and that the examples and the accompanying figures are merely to illustrate one or more particular implementations.

The terms, “and,” “and/or,” and “or” as used herein may include a variety of meanings that also is expected to depend at least in part upon the context in which such terms are used. Typically, “or” as well as “and/or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures, or characteristics. Though, it should be noted that this is merely an illustrative example and claimed subject matter is not limited to this example.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. A mobile device case comprising:
a recessed region to receive a mobile device;
a first connector disposed in said recessed region to receive video signals from said mobile device, wherein said first connector connects with said mobile device while said mobile device is received in said recessed region;
electronic circuitry to produce video signals based, at least in part, on said video signals;
a plurality of antennas;
a transmitter to transmit said video signals via said antennas;
one or more rechargeable batteries to provide power to said electronic circuitry and said transmitter; and
a second connector to receive power to recharge said rechargeable batteries.

2. The mobile device case of claim 1, wherein said video signals comprise High-Definition Multimedia Interface (HDMI) signals

3. The mobile device case of claim 1, further comprising a microprocessor to convert said video signals to HDMI signals.

4. The mobile device case of claim 1, further comprising a re-writeable register to maintain code readable by said mobile device via said first connector.

5. The mobile device case of claim 1, wherein said video signals comprise wireless high definition signals that include audio signals.

6. The mobile device case of claim 1, wherein said antennas are disposed in a side region of said mobile device case and said recessed region is disposed in a front region of said mobile device case.

7. The mobile device case of claim 1, wherein said transmitter is capable of transmitting said video signals at a rate greater than 4.0 gigabits per second.

8. The mobile device case of claim 1, wherein said second connector is disposed on said mobile device case so as to be connectable to a docking station.

9. The mobile device case of claim 1, wherein said second connector is capable of receiving said power from a docking station.

10. The mobile device case of claim 1, wherein said first connector comprises a first configuration, and wherein said first connector is interchangeable with another connector comprising a second configuration.

11. The mobile device case of claim 1, further comprising power circuitry to provide power to said mobile device from said one or more rechargeable batteries.

12. The mobile device case of claim 1, wherein said electronic circuitry comprises a wireless high definition (WiHD) integrated circuit.

13. The mobile device case of claim 1, wherein said plurality of antennas comprises ten or more antennas.

14. A method of operating a mobile device case with a mobile device, the method comprising:
receiving said mobile device at least partially in a recessed region of said mobile device case so as to connect a mobile device connector to a first mobile device case connector;
receiving video signals from said mobile device case via said mobile device connector and said first mobile device case connector;
producing video signals based, at least in part, on said video signals; and
transmitting said video signals via a plurality of antennas.

15. The method of claim 14, wherein said video signals comprise High-Definition Multimedia Interface (HDMI) signals

16. The method of claim 14, further comprising:
providing a code maintained in a re-writeable register to said mobile device via said mobile device connector.

17. The method of claim 14, further comprising:
receiving power via a second mobile device case connector from a docking station.

18. The method of claim 14, further comprising:
providing power to perform said producing and said transmitting said video signals using one or more re-chargeable batteries disposed in said mobile device case.

19. The method of claim 14, further comprising:
providing power to said mobile device using one or more re-chargeable batteries disposed in said mobile device case.

20. The method of claim 14, wherein said transmitting said video signals is performed at a rate greater than 4.0 gigabits per second.
